(19) United States
(12) Patent Application Publication
(10) Pub. No.: US 2021/0209290 A1
(43) Pub. Date: Jul. 8, 2021

(54) METHOD FOR CREATING XML DOCUMENT AND COMPUTING DEVICE IMPLEMENTING THE SAME

(71) Applicant: GeoBlueLab Inc., Seoul (KR)

(72) Inventor: Hyuntaek KWON, Seoul (KR)

(21) Appl. No.: 17/140,389

(22) Filed: Jan. 4, 2021

(30) Foreign Application Priority Data
Jan. 7, 2020 (KR) 10-2020-0001852

(51) Int. Cl. G06F 40/143; G06F 40/106

(52) U.S. Cl. CPC G06F 40/143; G06F 40/106

(57) ABSTRACT

A method for generating an extensible markup language (XML) document by a computing device comprises generating a structure source code of the XML document using a source code of a hypertext markup language (HTML) form corresponding to the XML document, generating a data XML using data information extracted from the structure source code of the XML document, generating a view XML including view information for displaying the data information on the XML document, generating an integrated XML by combining the data XML and the view XML, and generating the XML document by extracting the view information from the integrated XML using a common extensible stylesheet language (XSL) and combining the integrated XML and the common XSL.

### CROSS-REFERENCE TO RELATED APPLICATION(S)

This application claims priority to Korean Patent Application No. 10-2020-001852 filed in the Korean Intellectual Property Office on Jan. 7, 2020 the disclosure of which is incorporated by reference herein in its entirety.

### TECHNICAL FIELD

The disclosure relates to a method for creating an XML document and a computing device implementing the same.

### DISCUSSION OF RELATED ART

XML (eXtensible Markup Language) is an Internet document standard. XML has been designated as an Internet document standard by the World Wide Web Consortium (W3C) and inherits the strengths of SGML to overcome the expressional limitations of HTML conventionally used.

XML owns the advantages of SGML and thus has the characteristics of extensibility, structure, and validation. In other words, in XML, the information provider may arbitrarily define a new tag set and attributes, and the user may create a new tag set at his own convenience or to classify his or her data. The structure of a document implemented in XML allows successive overlaps and may provide grammatical distinctions within the document for verification of the structure of the document. Therefore, when an application that verifies the document structure accepts a document implemented in XML, errors in the document may easily be determined.

In implementing an XML document using XML, a data XML is created, and a view XSL is created using style sheet language, and then an XML document is generated by combining the data XML and view XSL. Here, the data XML is in charge of the data area in the XML document, and the view XSL is in charge of the view area in the XML document.

To create multiple XML documents with different display methods in the conventional XML document creation process, the same number of data XMLs and view XSLs as the generated XML documents need to be created. For example, to create ten XML documents with different display methods, ten data XMLs and ten View XSLs corresponding to the data XMLs are required. As such, a user who desires to create different XML documents ends up consuming significant time in generating different data XMLs and view XSLs.

Conventional data XML generation methods adopt one-to-one mapping with the structure of the XML document using the xpath scheme in the HTML form corresponding to the XML document. However, since this method uses xpath in HTML, it is difficult to utilize the source code of existing HTML, and it is impossible to use various web frameworks such as the spring framework. In particular, since “I” commonly used as a separator in xpath and URL needs to be separately used, developers have difficulty in work.

### SUMMARY

According to an embodiment, there is provided a technology of using a plurality of view XMLs with different pieces of view information while repetitively using one data XML rather than generating multiple data XMLs to generate a plurality of XML documents with different display methods.

According to an embodiment, there is provided a technology of creating XML documents to display various pieces of data information in various manners using a plurality of view XMLs with different pieces of view information even when using a plurality of data XMLs.

According to an embodiment, there is provided a technology that uses a method of mapping the name attribute of the source code of the HTML form and the node value of the structure source code of the XML document without using xpath when generating data XML.

According to an embodiment, a method for generating an extensible markup language (XML) document by a computing device comprises generating a structure source code of the XML document using a source code of a hypertext markup language (HTML) form corresponding to the XML document, generating a data XML using data information extracted from the structure source code of the XML document, generating a view XML including view information for displaying the data information on the XML document, generating an integrated XML by combining the data XML and the view XML, and generating the XML document by extracting the view information from the integrated XML using a common extensible stylesheet language (XSL) and combining the integrated XML and the common XSL.

Generating the data XML includes extracting at least one name attribute from the source code of the HTML form, generating the structure source code of the XML document by converting the name attribute to a node value according to a predetermined criterion and sorting the node value, and extracting a value attribute corresponding to the node value in the structure source code of the XML document from the source code of the HTML form, and generating the data XML using the extracted value attribute. The value attribute is the data information.

Generating the view XML includes generating the view XML by configuring the view information in the structure source code of the XML document.

Generating the integrated XML includes generating the integrated XML by sequentially combining a source code of the view XML and a source code of the data XML.

The common XSL has a source code predetermined based on the structure source code of the XML document.

Extracting the view information includes extracting the view information included in the view XML by allowing the common XSL to access the integrated XML via xpath.

Generating the XML document includes generating an HTML file by combining the view XML and the common XSL and setting the HTML file as the XML document.

According to an embodiment, a method for generating a plurality of XML documents by a computing device comprises generating each of structure source codes of the plurality of XML documents using a source code of an HTML form corresponding to each of the plurality of XML documents, generating a data XML using data information extracted from the structure source codes of the XML documents, generating a plurality of view XMLs individually including view information for displaying the data information on each XML document in different methods, generating a plurality of integrated XMLs by combining the data XML and each of the plurality of view XMLs, and generating the plurality of XML documents by combining the integrated XMLs and common XSLs.

Generating the data XML includes extracting at least one common name attribute from the source code of the HTML form; converting the common name attribute to a node value according to a predetermined criterion, generating structure source codes of the plurality of XML documents by sorting the node value, and extracting a value attribute corresponding to the node value in the structure source codes of the XML documents from the source code of the HTML form, and generating the data XML using the extracted value attribute. The value attribute is the data information.

Generating the plurality of view XMLs includes generating the plurality of view XMLs by configuring view information for displaying in different methods in the structure source codes of the XML documents.

Generating the plurality of integrated XMLs includes generating the plurality of integrated XMLs by sequentially combining source codes of the plurality of view XMLs and a source code of the data XML.

The common XSLs have a source code predetermined based on the structure source codes of the plurality of XML documents.

Extracting the view information includes extracting the view information from the view XML included in each of the plurality of integrated XMLs by allowing the common XSLs to access the plurality of integrated XMLs via xpath.

Generating the XML documents includes generating a plurality of HTML files by combining the integrated XMLs and the common XSLs and setting the plurality of HTML files as the plurality of XML documents.

According to various embodiments of the disclosure, it is possible to minimize the generation of data XMLs in generating a plurality of XML documents, thus effectively reducing the working time of a user creating XML documents.

According to various embodiments of the disclosure, since different pieces of data information may be displayed in different ways according to user settings, user convenience may be improved.

According to various embodiments of the disclosure, since xpath is not used in generating data XML, the existing HTML source code may be used, various web frameworks may be used, and the “/”-related issues may be avoided.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a view illustrating a method of generating an XML document by a computing device according to an embodiment of the disclosure;

FIG. 2 is a view illustrating a method of generating data XML by a computing device according to an embodiment of the disclosure;

FIG. 3 is a view illustrating a structure of an XML document including a content area, a container area, a block area, and an item area according to an embodiment of the disclosure;

FIGS. 4A and 4B are views illustrating a new file including a source code for a content area, a source code for a container area, a source code for a block area, and a source code for an item area according to an embodiment of the disclosure;

FIGS. 5A, 5B, and 5C are views illustrating a method of generating an integrated XML by a computing device according to an embodiment of the disclosure;

FIG. 6 is a view illustrating a common XSL according to an embodiment of the disclosure.

FIGS. 7A and 7B are views illustrating a method of extracting view information included in view XML by using a common XSL by a computing device according to an embodiment of the disclosure.

FIGS. 8A, 8B, and 8C are views illustrating a method of combining view XML information with a common XSL by a computing device according to an embodiment of the disclosure.

FIG. 9 is a view illustrating a method of generating a plurality of XML documents displaying the same data information in different ways according to an embodiment of the disclosure.

FIG. 10 is a view illustrating a method of generating a plurality of XML documents displaying different data information in different ways according to an embodiment of the disclosure.

FIG. 11 is a view illustrating a method of generating a plurality of XML documents by a computing device according to an embodiment of the disclosure.

FIG. 12 is a view illustrating another method of generating a plurality of XML documents by a computing device according to an embodiment of the disclosure.

### DETAILED DESCRIPTION

Embodiments of the disclosure are now described with reference to the accompanying drawings in such a detailed manner as to be easily practiced by one of ordinary skill in the art. However, the disclosure may be implemented in other various forms and is not limited to the embodiments set forth herein.

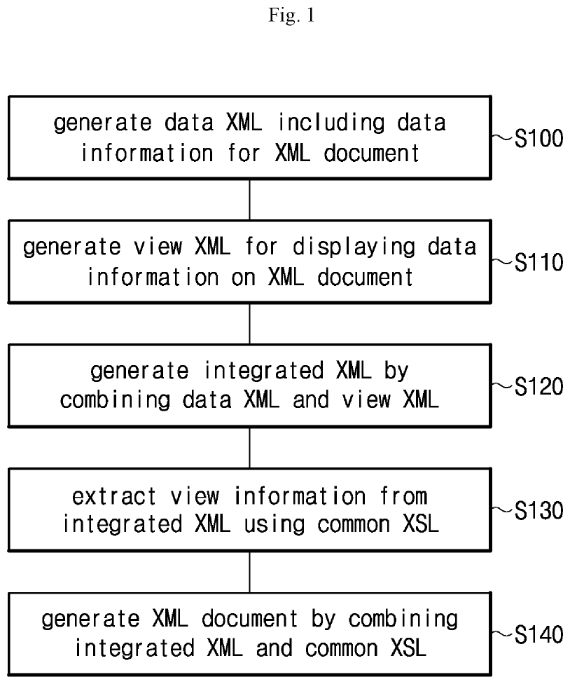

FIG. 1 is a view illustrating a method of generating an XML document by a computing device according to an embodiment of the disclosure.

Here, the computing device may be a computing device driven by at least one processor, and may be, e.g., a desktop computer, a smart phone, or personal digital assistants (PDAs).

Referring to FIG. 1, the computing device generates a data XML including data information of an XML document (S100).

For example, the computing device extracts the name attribute and the value attribute corresponding to the name attribute from the source code of the HTML form corresponding to the XML document, converts the name attribute to a node value according to a predetermined criterion, generates a structure source code of the XML document by sorting or arranging the node value, extracts the value attribute corresponding to the name attribute of the structure source code of the XML document from the source code of the HTML form, and creates a data XML by using the extracted value attribute.

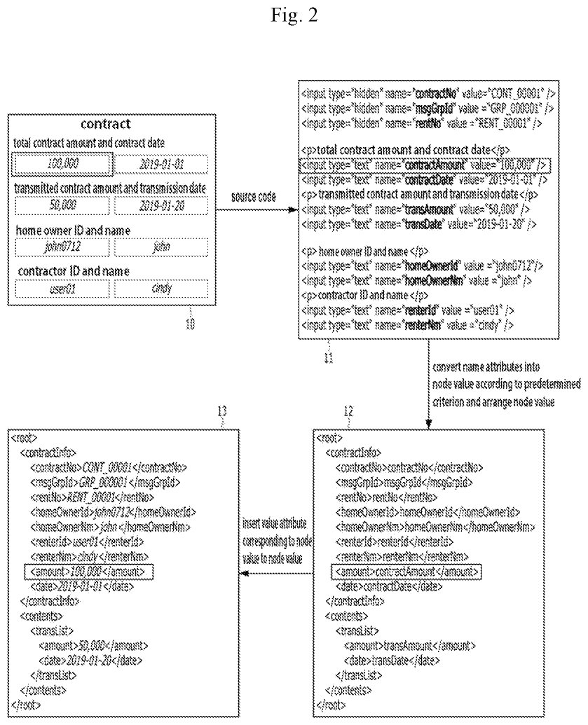

Referring to FIG. 2, the HTML form 10 corresponding to the XML document is a “contract,” and the HTML form 10 includes text fields, such as “total contract amount and contract date,” “transmitted contract amount and transmission date,” “home owner ID and name,” and “contractor ID and name.” When “100,000,” “Jan. 1, 2019,” “50,000,” “Jan. 20, 2019,” “john0712,” “john,” “user01,” and “cindy,” as input values, are entered to the text fields, the source code 11 of the HTML form includes a name attribute for each text field and a value attribute for each input value.

For example, the source code 11 of the HTML form may include the name attribute, name=“contractAmount,” of the text field for “100,000” of the “total contract amount and contract date” of the HTML form and the value attribute, value=“100,000,” for the name attribute.

The computing device extracts at least one or more name attributes from the source code 11 of the HTML form, converts the name attributes into node values according to a predetermined criterion, and sorts or arranges the node values to thereby form a structure source code of the XML document 12.

For example, the computing device may convert the name attribute, name=“contractAmount,” included in the source code 11 of the HTML form to the node value, “<amount> contractAmount</amount>,” and sequentially arrange the node values in the order in which they are sorted or arranged in the source code 11 of the HTML form.

Therefore, the structure source code 12 of the XML document includes the name attribute of the source code 11 of the HTML form, and the computing device extracts the value attribute corresponding to the node value of the structure source code 12 of the XML document from the HTML form and creates a data XML 13 using the extracted value attribute. In this case, the value attribute corresponds to data information.

For example, the computing device generates “<amount>100,000</annount>” by extracting the value attribute, value=“100,000,” corresponding to the node value, “<amount>contractAmount</amount>,” from the source code 11 of the HTML form and inserting the extracted value attribute, value=“100,000,” to the corresponding node value, and the computing device repeats such process on each node value, thereby generating the data XML 13.

The method of generating the data XML 13 according to the disclosure uses a scheme of one-to-one mapping the name attribute of the source code 11 of the HTML form and the node value of the structure source code 12 of the XML document. In other words, since the method of generating the data XML 13, according to the disclosure, does not use xpath, the source code 11 of the existing HTML form may be used directly, and various web frameworks such as the spring framework may be used. In particular, according to the disclosure, the method may avoid the issues with mixed use of “I” as a separator in xpath and URL.

Thereafter, the computing device generates a view XML including view information for displaying the data information on the XML document (S110).

For example, the computing device generates a view XML by setting or configuring view information in the structure source code of the XML document.

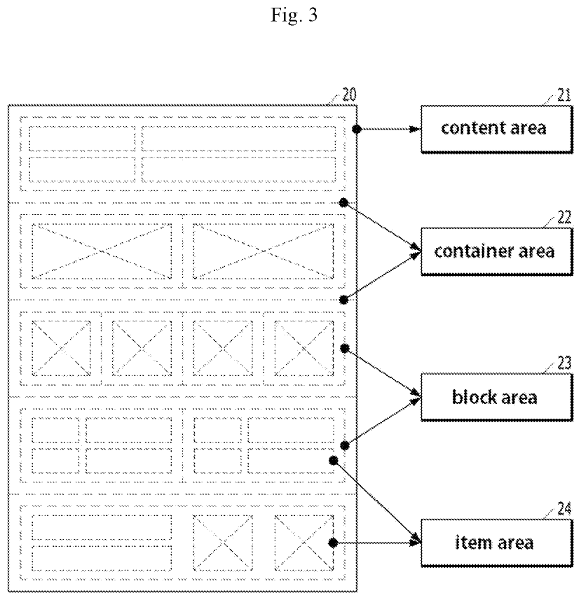

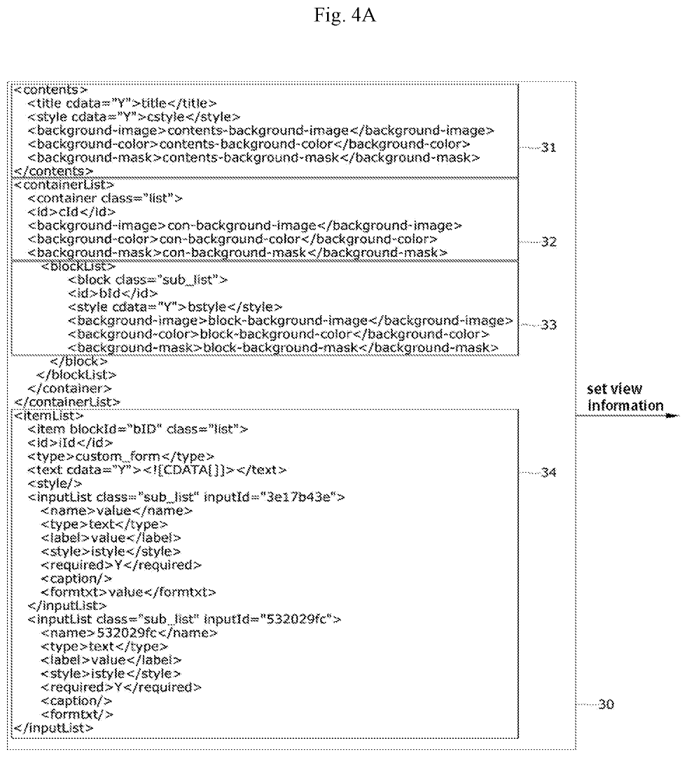

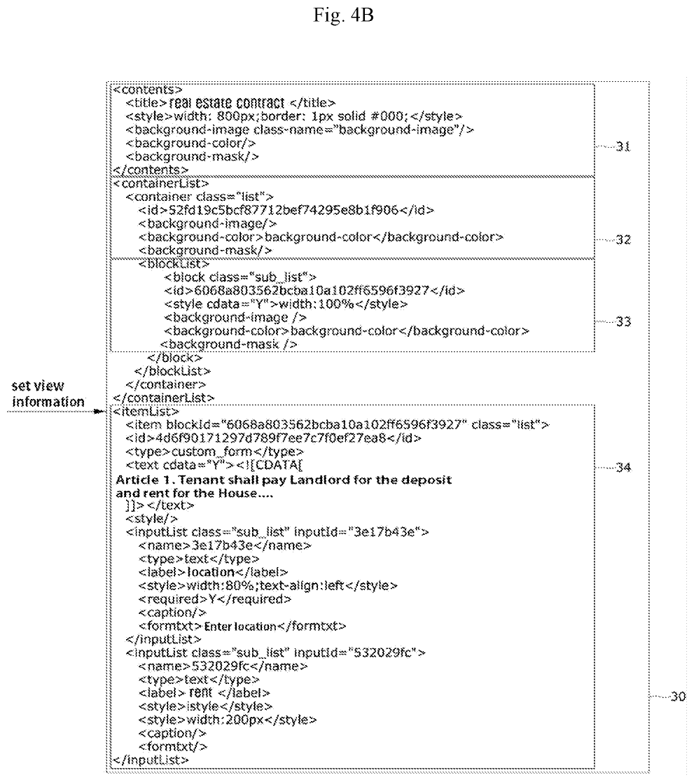

FIG. 3 is a view illustrating a structure 20 of an XML document including a content area 21, a container area 22, a block area 23, and an item area 24 according to an embodiment of the disclosure. FIGS. 4A and 4B are views illustrating a new file 30 including a source code 31 for a content area, a source code 32 for a container area, a source code 33 for a block area, and a source code 34 for an item area according to an embodiment of the disclosure.

Referring to FIG. 3, when the structure 20 of an XML document includes a content area 21, a container area 22, a block area 23, and an item area 24, the computing device generates a source code according to the XML document structure 20. In this case, the computing device may generate a new file 30 for the structure source code of the XML document to generate the source code.

Referring to FIGS. 4A and 4B, the new file 30 includes a source code 31 for the content area, a source code 32 for the container area, a source code 33 for the block area, and a source code 34 for the item area.

Here, the source code 31 for the content area includes page information for the XML document structure 20, the source code 32 for the container area includes body configuration information for the XML document structure 20, the source code 33 for the block area includes paragraph configuration information for the XML document structure 20, and the source code 34 for the item area includes text information displayed in the XML document.

The computing device receives view information for the XML document structure 20 from the user. Here, the view information may include, as user setting values for the XML document structure 20, content title information (title), content style information (cstyle), content background information (contents-background-image, contents-background-color, contents-background-mask), container ID information (cId), container background information (container-background-image, container-background-color, containerbackground-mask), block ID information (bId)), block style information (bstyle), block background information (block-background-image, block-background-color, block-backgroundmask), item ID information (iId), and item style information (istyle).

The computing device generates view XML 40 by setting or configuring the received view information in the structure source code of the XML document. For example, the computing device inserts the received view information, as a field value, in the field corresponding to each view information in the structure source code of the XML document included in the new file 30.

Thereafter, the computing device combines the data XML and the view XML to generate an integrated XML (S120).

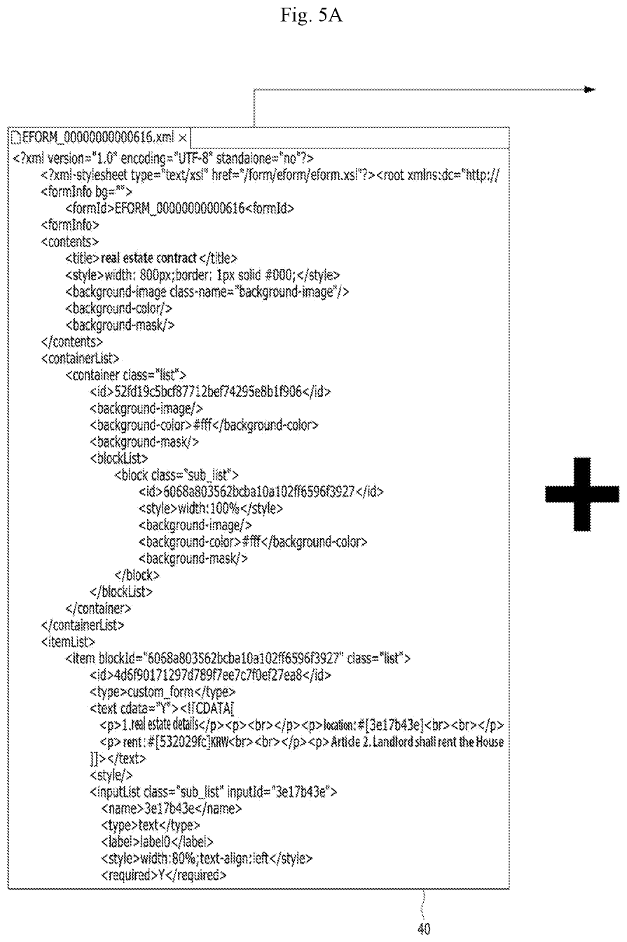

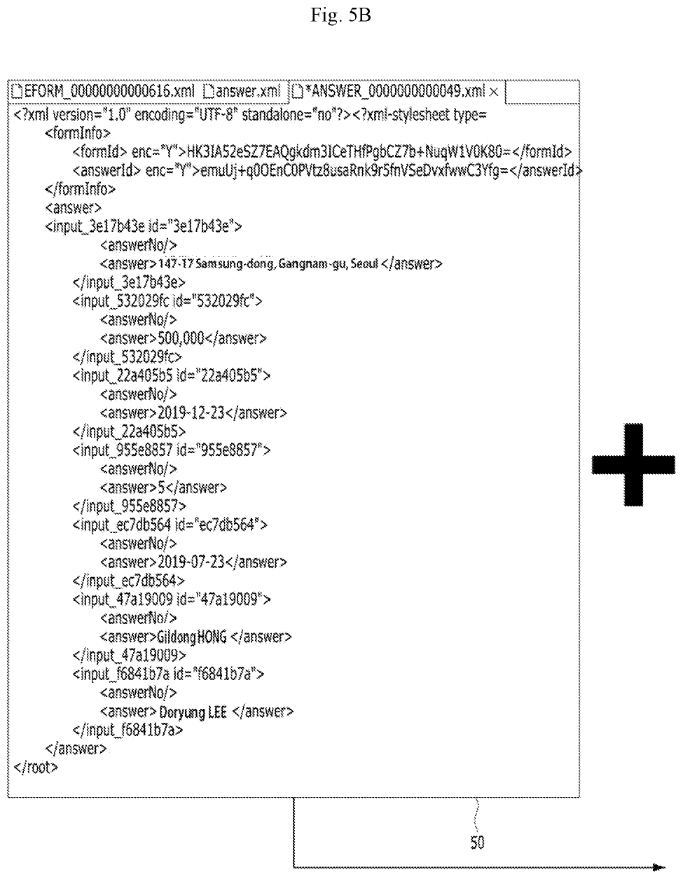

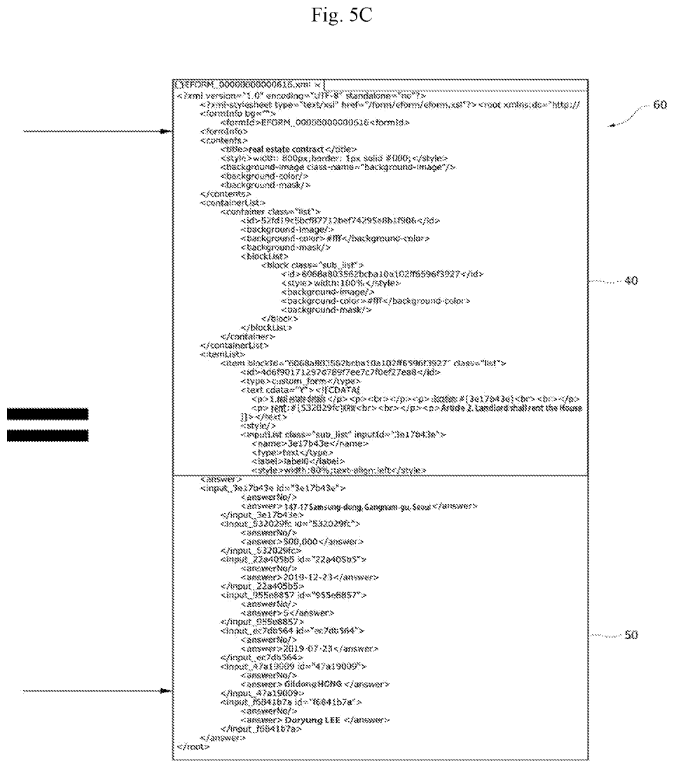

FIGS. 5A, 5B, and 5C are views illustrating a method of generating an integrated XML by a computing device according to an embodiment of the disclosure.

Referring to FIGS. 5A to 5C , the computing device sequentially combines the source code 40 of the view XML and the source code 50 of the data XML and uses the combined source code to thereby generate the integrated XML 60.

Thereafter, the computing device extracts the view information from the integrated XML using a common XSL (S130). image, Here, the common XSL has a source code predetermined according to the structure source code of the XML document. As described in connection with FIG. 3, the structure 20 of the XML document is divided into the content area 21, the container area 22, the block area 23, and the item area 24, so that the common XSL may have a source code predetermined or preset according to the content area 21, the container area 22, the block area 23, and the item area 24.

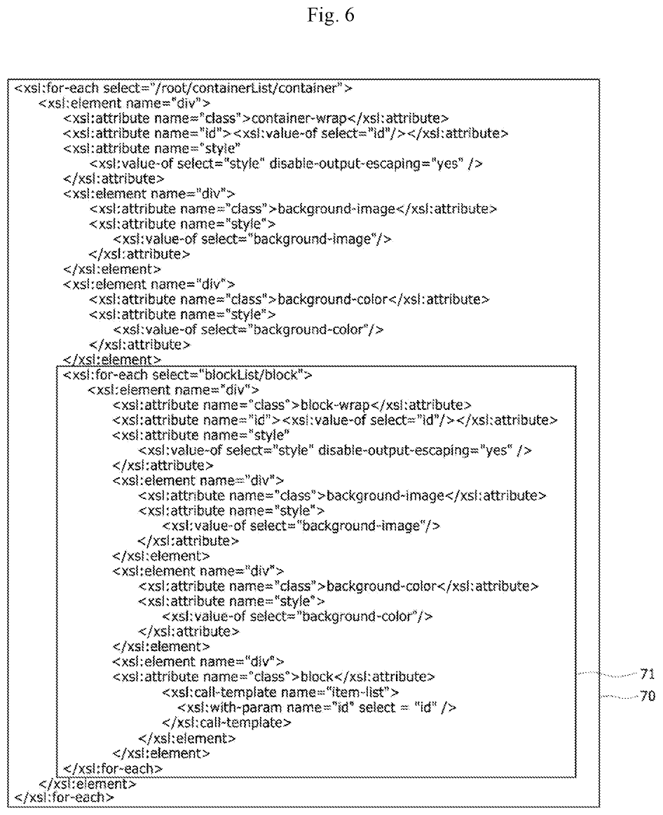

For example, referring to FIG. 6, the common XSL 70 may include a source code 71 including view information for the block area 23 of the structure 20 of an XML document.

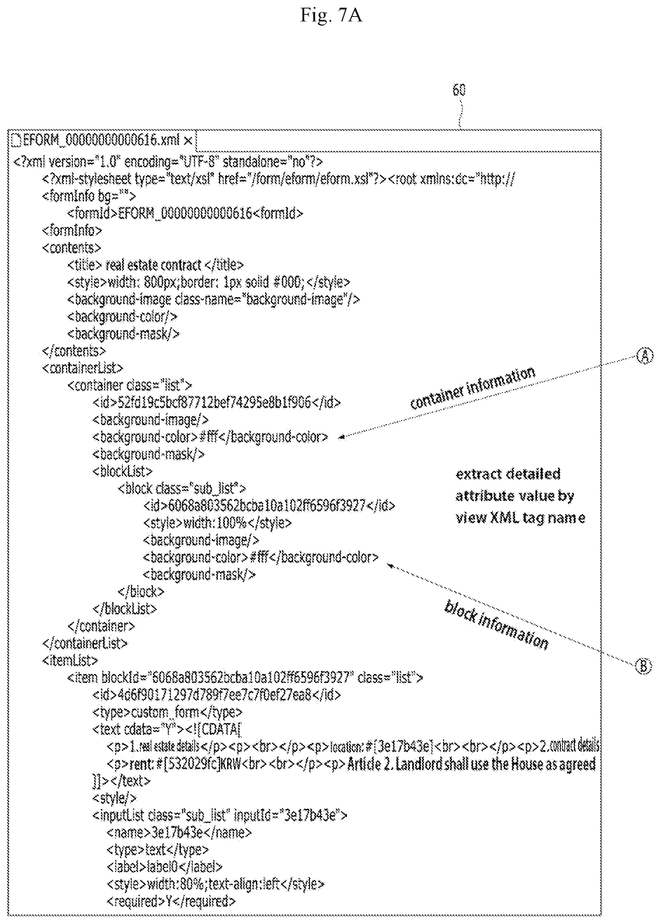

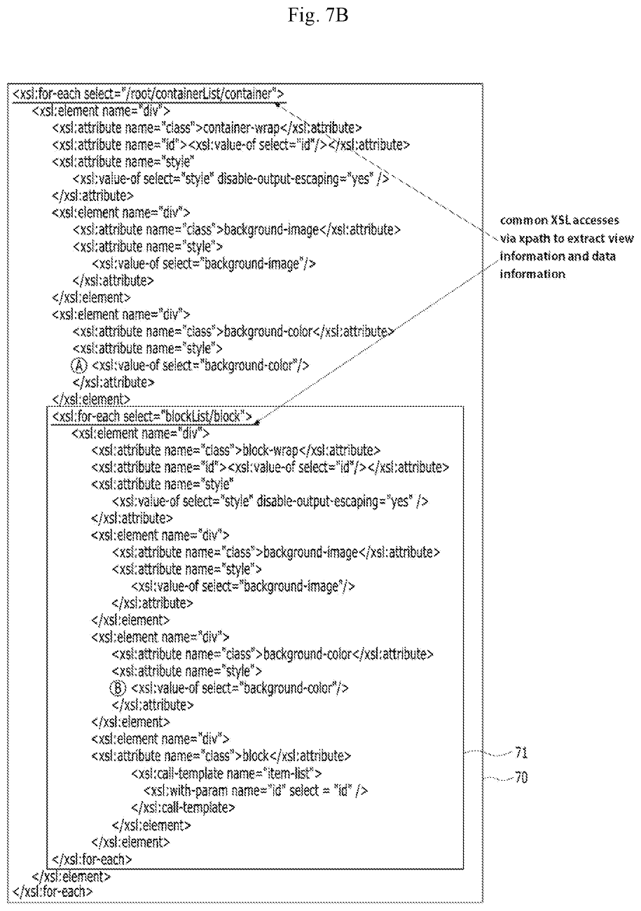

FIGS. 7A and 7B are views illustrating a method of extracting view information included in view XML by using a common XSL by a computing device according to an embodiment of the disclosure.

Referring to FIGS. 7A and 7B, the common XSL 70 accesses the integrated XML 60 through an xpath and extracts the view information included in the view XML 40. In this case, the common XSL 70 may extract the attribute value using the tag name of the view XML 40 included in the integrated XML 60 so as to extract the detailed attribute value. Further, the common XSL 70 may access the integrated XML 60 through an xpath and extract data information included in the data XML.

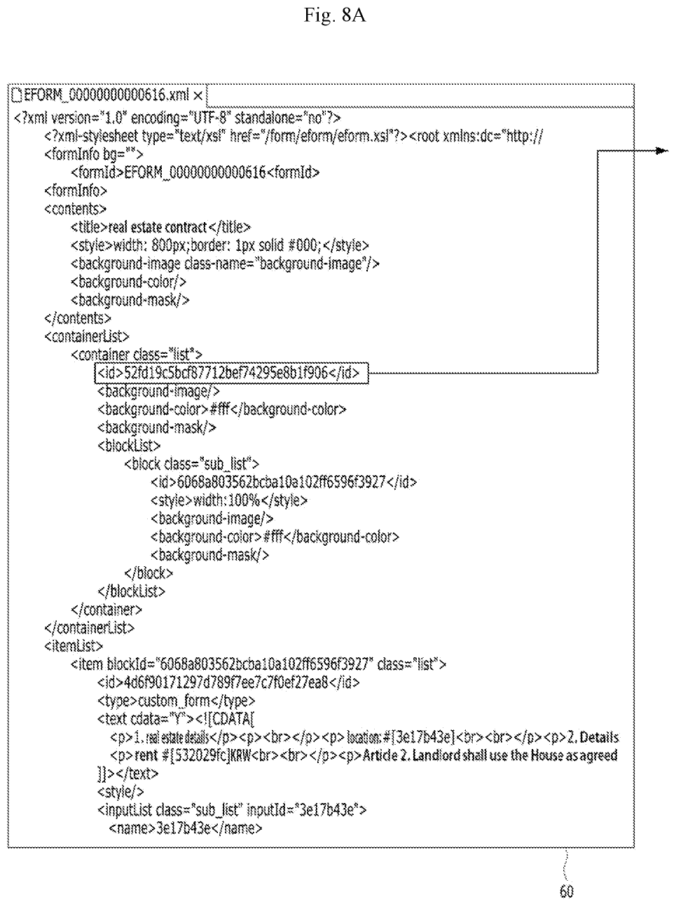

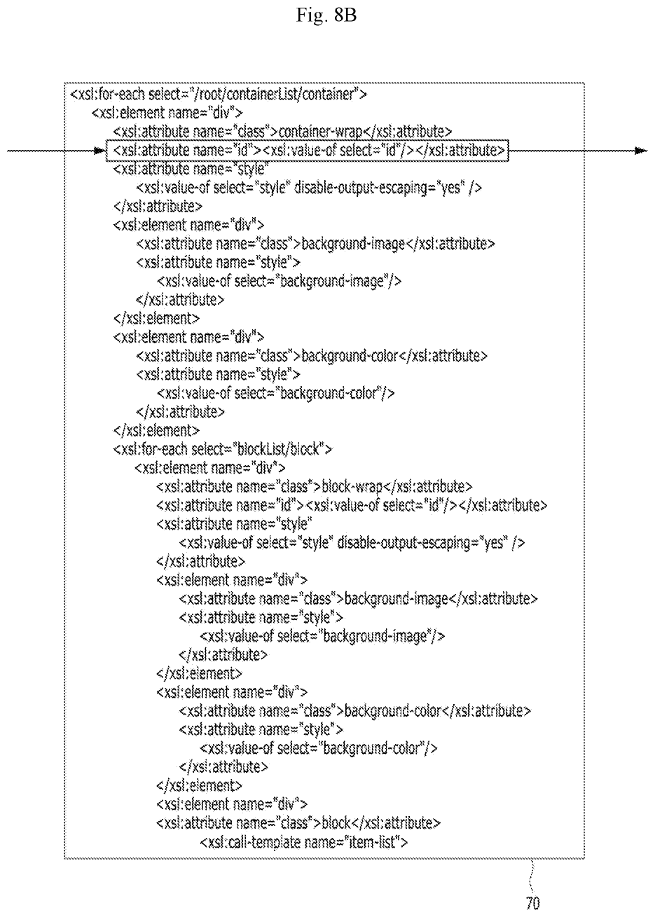

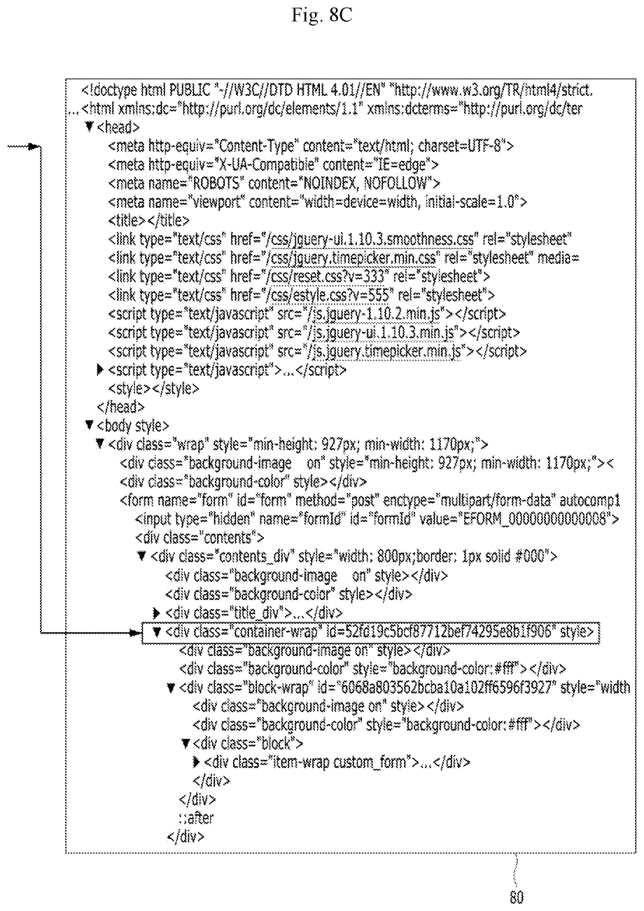

FIGS. 8A, 8B, and 8C are views illustrating a method of combining view XML information with a common XSL by a computing device according to an embodiment of the disclosure.

For example, referring to FIGS. 8A to 8C, when the XSL file and the XML file are combined, it is automatically converted into an HTML file, and in this case, the HTML attribute value changes according to the value defined in the XSL file.

For example, the “<id>52fd19c5bcf87712bef74295e8b1f906</id>field in the view XML 40 included in the integrated XML 60 is changed to have the attribute value, “<div class=-container-wrap” id=52fd19c5bcf87712bef74295e8b1f906” style>, according to the corresponding field value, “<xsl:attribute name=”id“><xsl:value-of select=”id“/><xsl: attribute>,” in the common XSL 70, and an HTML file 80 with such changed attribute value is generated.

In this case, the computing device generates the HTML file 80 in which the attribute value has been changed.

Thereafter, the computing device generates an XML document by combining the integrated XML and the common XSL (S140).

For example, the computing device generates an HTML file by combining the integrated XML and the common XSL, and sets the HTML file as an XML document.

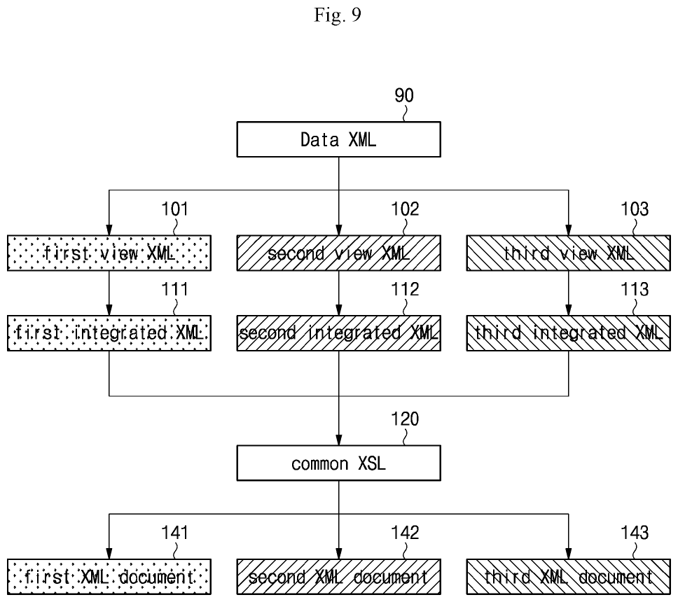

FIG. 9 is a view illustrating a method of generating a plurality of XML documents displaying the same data information in different ways according to an embodiment of the disclosure.

Referring to FIG. 9, the computing device creates integrated XMLs by combining a single data XML and each of a plurality of view XML files, and creates a plurality of XML documents by combining the integrated XMLs with a common XSL. In connection with FIG. 9, no duplicate descriptions is given of what has been described above in connection with FIGS. 1 to 8.

For example, the computing device generates a plurality of integrated XMLs 111, 112, and 113 by combining the data XML 90 with a plurality of view XMLs 101, 102, and 103. For example, when data information is displayed in three XML documents in different ways, the computing device combines the data XML 90, which includes the data information, with a first view XML 101, a second view XML 102, and a third view XML 103, which includes different view information, thereby generating a first integrated XML 111, a second integrated XML 112, and a third integrated XML 113.

Thereafter, the computing device generates a plurality of XML documents 141, 142, and 143 using the common XSL 120. Since the plurality of XML documents 141, 142, and 143 are generated using the view XMLs including different view information, the same data information is displayed in different ways.

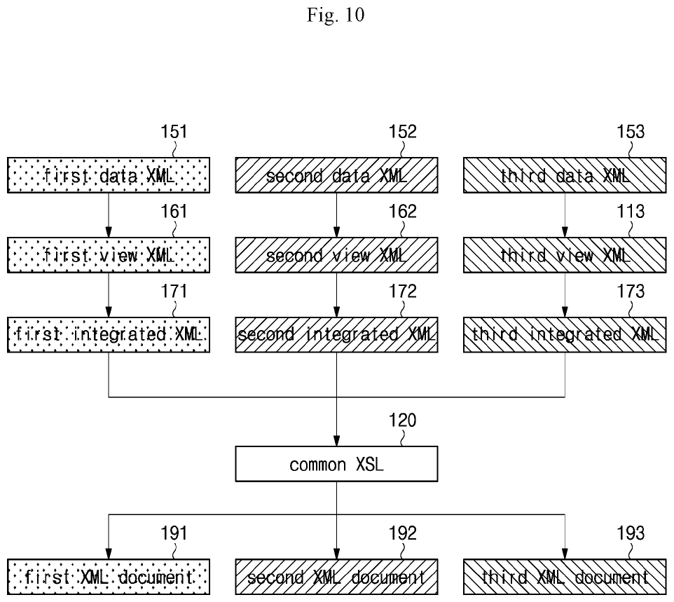

FIG. 10 is a view illustrating a method of generating a plurality of XML documents displaying different data information in different ways according to an embodiment of the disclosure.

Referring to FIG. 10, the computing device generates a plurality of integrated XML documents by individually combining a plurality of data XMLs and a plurality of view XML files. In connection with FIG. 10, no duplicate descriptions is given of what has been described above in connection with FIGS. 1 to 8.

For example, the computing device generates a plurality of integrated XMLs 171, 172, and 173 by combining the plurality data XMLs 151, 152, and 153 with the plurality of view XMLs 161, 162, and 163.

Although FIG. 10 illustrates that the first data XML 151 and the first view XML 161 are combined to generate the first integrated XML 171, the second data XML 152 and the second view XML 162 are combined to generate the second integrated XML 172, and the third data XML 153 and the third view XML 163 are combined to generate the third integrated XML 173, the data XML may be combined with any view XML to generate an integrated XML according to the user's settings. For example, the first data XML 151 may be combined with the third view XML 163 to generate an integrated XML. In other words, referring to FIG. 10, a total of 9 types of integrated XMLs may be generated.

Thereafter, the computing device generates a plurality of XML documents 191, 192, and 193 using the common XSL 120.

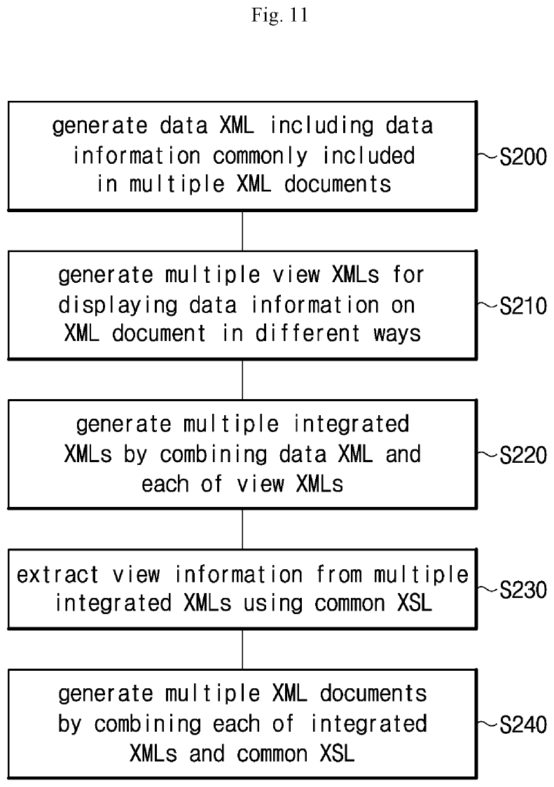

FIG. 11 is a view illustrating a method of generating a plurality of XML documents by a computing device according to an embodiment of the disclosure.

In connection with FIG. 11, no duplicate descriptions is given of what has been described above in connection with FIGS. 1 to 10.

Referring to FIG. 11, the computing device generates a data XML including data information commonly included in a plurality of XML documents (S200).

For example, the computing device individually generates structure source codes of a plurality of XML documents using source codes of HTML forms individually corresponding to the plurality of XML documents, and generates a data XML using the data information extracted from the structure source codes of the plurality of XML documents.

For example, the computing device extracts at least one or more common name attributes from the HTML form source codes, converts the common name attributes to node values according to a predetermined criterion, generates structure source codes of the plurality of XML documents by sorting or arranging the node values, extracts the value attributes corresponding to the node values in the structure source codes of the plurality of XML documents from the HTML form source codes, and creates a data XML by using the extracted value attribute.

Thereafter, the computing device generates a plurality of view XMLs individually including view information for displaying the data information on the XML documents (S210).

For example, the computing device generates a plurality of view XMLs by setting or configuring the view information for displaying in different ways in the structure source code of the XML document.

The computing device generates a plurality of view XMLs including the view information for displaying the data information in different ways (S210). In this case, the plurality of view XMLs include different view information, so that the data information is displayed on the plurality of XML documents in different ways.

The computing device generates a plurality of integrated XMLs by combining the data XML and each of the plurality of view XMLs (S220).

For example, the computing device generates a plurality of integrated XMLs by sequentially combining the source codes of the plurality of view XMLs and the source code of the data XML.

The computing device extracts view information from each of the plurality of integrated XMLs using the common XSL (S230).

The computing device generates a plurality of XML documents in which data information is displayed in different ways by combining each of the integrated XMLs and the common XSL (S240).

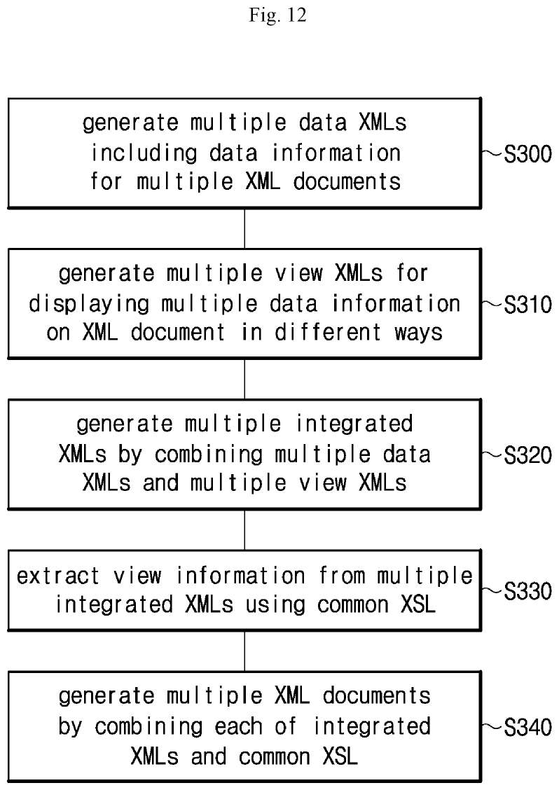

FIG. 12 is a view illustrating another method of generating a plurality of XML documents by a computing device according to an embodiment of the disclosure.

In connection with FIG. 12, no duplicate descriptions is given of what has been described above in connection with FIGS. 1 to 11.

Referring to FIG. 12, the computing device generates a plurality of data XMLs individually including the data information of a plurality of XML documents (S300).

For example, the computing device individually generates structure source codes of a plurality of XML documents using source codes of HTML forms individually corresponding to the plurality of XML documents, and generates a plurality of data XMLs using the data information extracted from each of the structure source codes of the plurality of XML documents.

In this case, the computing device extracts at least one or more name attributes from the HTML form source codes individually corresponding to the XML documents, converts the name attributes to node values according to a predetermined criterion, generates structure source codes of the plurality of XML documents by sorting or arranging the node values, extracts the value attributes corresponding to the node values in the structure source codes of the plurality of XML documents from the HTML form source codes, and creates a plurality of data XMLs by using the extracted value attributes.

The computing device generates a plurality of view XMLs including view information for displaying a plurality of data information in different ways (S310). In this case, the plurality of view XMLs include different view information, so that the different data information is displayed on the plurality of XML documents in different ways.

The computing device generates a plurality of integrated XMLs by combining the plurality of data XMLs and the plurality of view XMLs (S320).

For example, the computing device generates a plurality of integrated XMLs by sequentially combining the source codes of the plurality of view XMLs and the source codes of the plurality of data XMLs.

The computing device extracts view information from each of the plurality of view XMLs using the common XSL (S330).

The computing device generates a plurality of XML documents in which different data information is displayed in different ways by combining each of the integrated XMLs and the common XSL (S340).

According to various embodiments of the disclosure, it is possible to minimize the generation of data XMLs in generating a plurality of XML documents, thus effectively reducing the working time of a user creating XML documents.

According to various embodiments of the disclosure, since different pieces of data information may be displayed in different ways according to user settings, user convenience may be improved.

According to various embodiments of the disclosure, since xpath is not used in generating data XML, the existing HTML source code may be used, various web frameworks may be used, and the “/”-related issues may be avoided.

The embodiments of the disclosure described above are not implemented only as a device, apparatus or method, but may rather be implemented as a program for implementing the functions corresponding to the configuration or components of the embodiments of the disclosure or as a recording medium recording or storing the program.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A method for generating an extensible markup language (XML) document by a computing device, the method comprising:
generating a structure source code of the XML document using a source code of a hypertext markup language (HTML) form corresponding to the XML document;
generating a data XML using data information extracted from the structure source code of the XML document;
generating a view XML including view information for displaying the data information on the XML document;
generating an integrated XML by combining the data XML and the view XML; and
generating the XML document by extracting the view information from the integrated XML using a common extensible stylesheet language (XSL) and combining the integrated XML and the common XSL.

2. The method of claim 1, wherein
generating the data XML includes:
extracting at least one name attribute from the source code of the HTML form;
generating the structure source code of the XML document by converting the name attribute to a node value according to a predetermined criterion and sorting the node value; and
extracting a value attribute corresponding to the node value in the structure source code of the XML document from the source code of the HTML form, and generating the data XML using the extracted value attribute, wherein the value attribute is the data information.

3. The method of claim 2, wherein generating the view XML includes generating the view XML by configuring the view information in the structure source code of the XML document.

4. The method of claim 1, wherein generating the integrated XML includes generating the integrated XML by sequentially combining a source code of the view XML and a source code of the data XML.

5. The method of claim 1, wherein the common XSL has a source code predetermined based on the structure source code of the XML document.

6. The method of claim 1, wherein extracting the view information includes extracting the view information included in the view XML by allowing the common XSL to access the integrated XML via xpath.

7. The method of claim 1, wherein generating the XML document includes generating an HTML file by combining the view XML and the common XSL and setting the HTML file as the XML document.

8. A method for generating a plurality of XML documents by a computing device, the method comprising:
generating each of structure source codes of the plurality of XML documents using a source code of an HTML form corresponding to each of the plurality of XML documents;
generating a data XML using data information extracted from the structure source codes of the XML documents;
generating a plurality of view XMLs individually including view information for displaying the data information on each XML document in different methods;
generating a plurality of integrated XMLs by combining the data XML and each of the plurality of view XMLs; and
generating the plurality of XML documents by combining the integrated XMLs and common XSLs.

9. The method of claim 8, wherein generating the data XML includes:
extracting at least one common name attribute from the source code of the HTML form;
converting the common name attribute to a node value according to a predetermined criterion;
generating structure source codes of the plurality of XML documents by sorting the node value; and
extracting a value attribute corresponding to the node value in the structure source codes of the XML documents from the source code of the HTML form, and generating the data XML using the extracted value attribute, wherein the value attribute is the data information.

10. The method of claim 9, wherein generating the plurality of view XMLs includes generating the plurality of view XMLs by configuring view information for displaying in different methods in the structure source codes of the XML documents.

11. The method of claim 8, wherein generating the plurality of integrated XMLs includes generating the plurality of integrated XMLs by sequentially combining source codes of the plurality of view XMLs and a source code of the data XML.

12. The method of claim 8, wherein the common XSLs have a source code predetermined based on the structure source codes of the plurality of XML documents.

13. The method of claim 8, wherein extracting the view information includes extracting the view information from the view XML included in each of the plurality of integrated XMLs by allowing the common XSLs to access the plurality of integrated XMLs via xpath.

14. The method of claim 8, wherein generating the XML documents includes generating a plurality of HTML files by combining the integrated XMLs and the common XSLs and setting the plurality of HTML files as the plurality of XML documents.
